(19) United States
(12) Patent Application Publication
(10) Pub. No.: US 2009/0133637 A1
(43) Pub. Date: May 28, 2009

(54) Pet Litter Receptacle

(75) Inventor: Troy Petersen, Rosemount, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Royal Pet Incorporated, Inver Grove Heights, MN (US)

(21) Appl. No.: 11/945,379

(22) Filed: Nov. 27, 2007

(51) Int. Cl. A01K 29/00

(52) U.S. Cl. 119/165

(57) ABSTRACT

A pet litter receptacle includes a back portion for accepting a selected amount of absorbent material and a front portion comprising a bottom surface having a plurality of protuberances extending upwardly therefrom. A wall separating the back portion and the front portion such that when the animal has completed utilizing the receptacle, the animal must step over the wall and engage at least on paw with at least one of the plurality of protuberances such that the animal's paw pads spread apart and release any absorbent material that was retained in the paw into the front portion.

### FIELD OF THE INVENTION

The present invention relates to a pet litter receptacle. More particularly, the present invention relates to pet litter receptacle that minimizes the undesired deposit of absorbent material within a housing unit.

### BACKGROUND OF THE INVENTION

Many domestic animals, such as dogs and cats, spend much of their day indoors. Cats are typically trained to utilize an indoor litter box to relieve themselves. Dogs are typically trained to go outside to relieve themselves.

Due to time demands on a dog's owner and/or family, there are many instances when a dog must remain indoors for an extended amount of time without the opportunity to relieve himself or herself outside. While pet owners understand that the dog must urinate and defecate, typical methods and devices that are utilized to allow the dog to relieve himself or herself within a housing unit have not eliminated the non-sanitary conditions associated with the dog urinating and defecating within the housing unit.

One method includes confining the dog to an area having a non-permeable floor where the dog can urinate and defecate without damaging the rest of the living area. However, upon returning home, the dog owner must clean and sanitize the floor.

Another alternative method includes training the dog to relieve himself or herself on newspaper spread out on the floor. While the owner can dispose of the newspaper once the owner returns home, the owner may also have to clean the underlying floor surface to remove any seepage through the newspaper.

Another alternative method includes providing a pan containing absorbent material such as cat litter for the pet to urinate and defecate within. However, the pet's paws entrap absorbent material between the pet's pads.

A paw of a cat or a dog includes pads that provide cushioning for the load-bearing limbs of the animal. The paw consists of a large, heart-shaped metacarpal pad for the front legs or a metatarsal pad for the rear legs, and generally four load bearing digit pads adjacent the metacarpal or metatarsal pads. In many instances when the pet uses a litter box containing the absorbent material, some of the absorbent material is wedged between the metacarpal pad and/or the metatarsal pad and the digit pads or between two adjacent digit pads. As the pet moves about the living area, pressure is placed upon the pads causing the pads to spread apart and releasing the absorbent material in unwanted areas of the housing unit. The unwanted deposit of the absorbent material causes the owner having to clean up the absorbent material that is spread throughout the housing unit.

### SUMMARY OF THE INVENTION

The present invention includes a pet litter receptacle having a back portion for accepting a selected amount of absorbent material and a front portion comprising a bottom surface having a plurality of protuberances extending upwardly therefrom. A wall separates the back portion and the front portion such that when the animal has completed utilizing the receptacle, the animal must step over the wall and engage at least on paw with at least one of the plurality of protuberances such that the animal's paw pads spread apart and release any absorbent material retained in the paw into the front portion.

### BRIEF DESCRIPTION OF THE DRAWINGS

FIG. 1 is a perspective view of the pet litter receptacle.

FIG. 2 is a left side view of the pet litter receptacle.

FIG. 3 is a right side view of the pet litter receptacle.

FIG. 4 is a front view of the pet litter receptacle.

FIG. 5 is a back view of the pet litter receptacle.

FIG. 6 is a top view of the pet litter receptacle.

### DETAILED DESCRIPTION OF ILLUSTRATIVE EMBODIMENTS

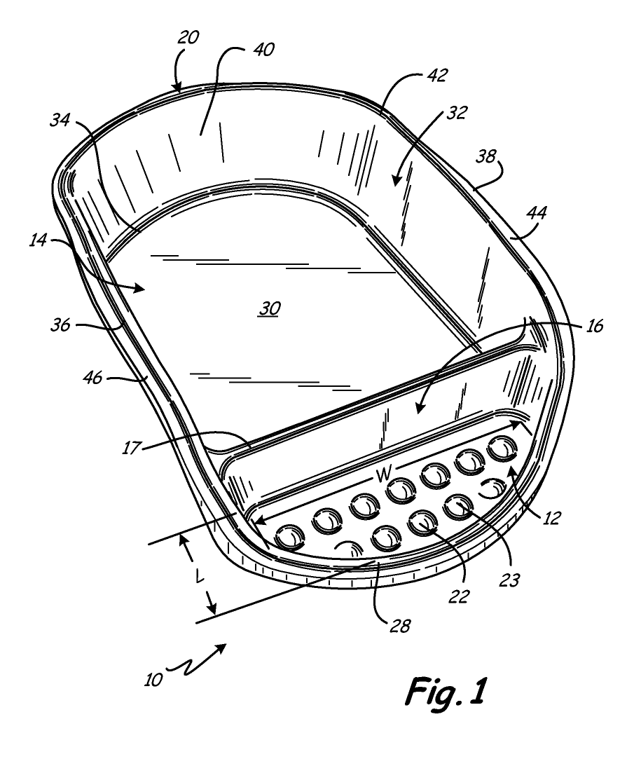

A litter receptacle is generally illustrated in FIG. 1 at 10. The litter receptacle 10 includes a front section 12 and a back section 14 separated by a wall 16. The back section 14 has a volume sufficient to contain a selected amount of absorbent material, such as cat litter, that absorbs moisture in urine and/or feces. The litter receptacle 10 is suited for any indoor pet, particularly dogs and cats, that have paw pads that collect the absorbent material and typically deposit the absorbent material retained within the pet's paws elsewhere in a living area. The litter receptacle 10 prevents the unwanted deposit of the absorbent material within the living area.

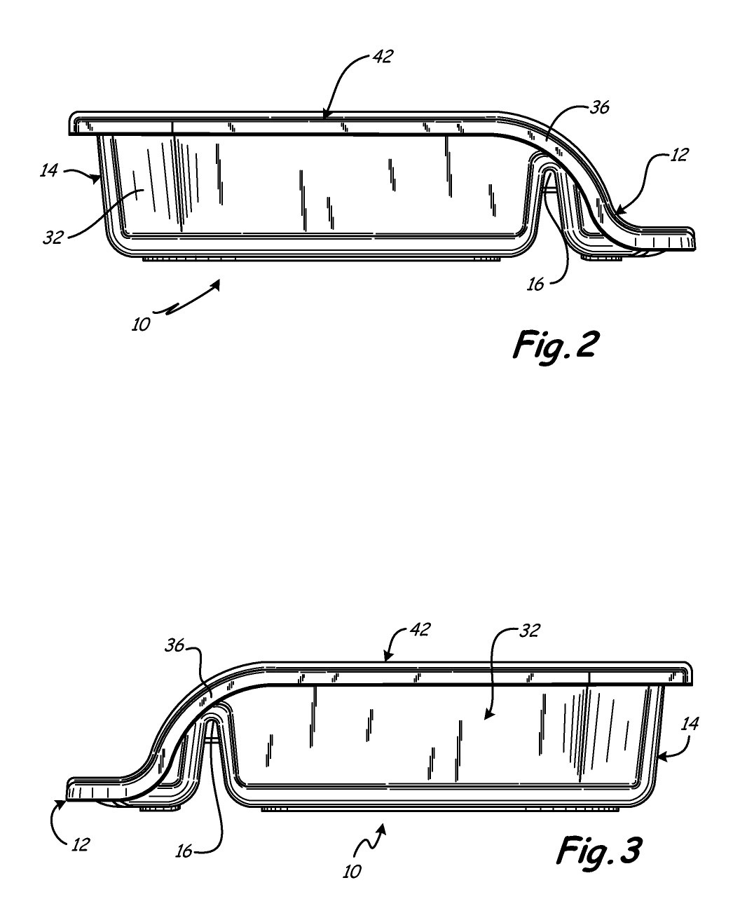

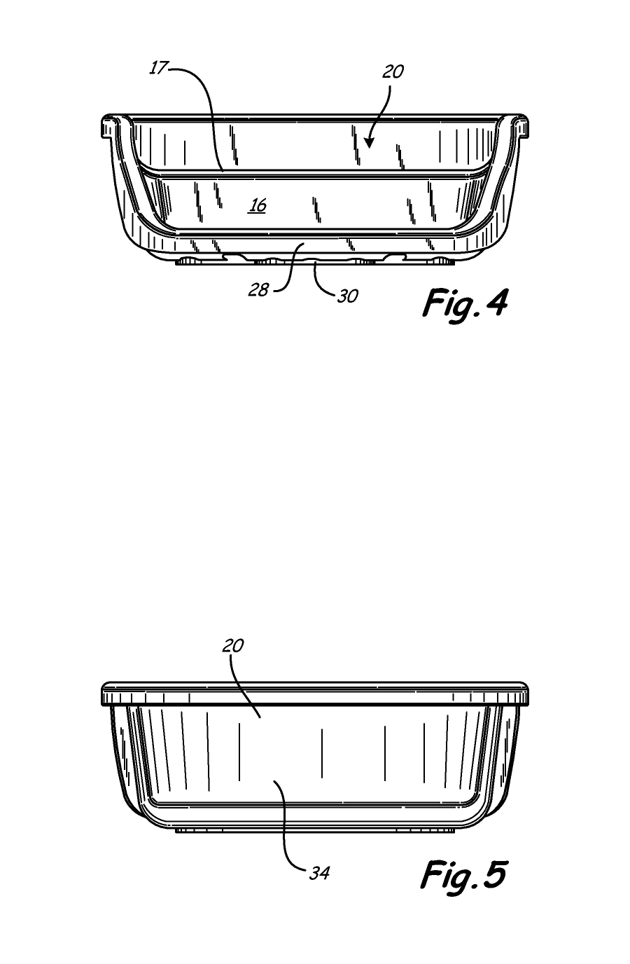

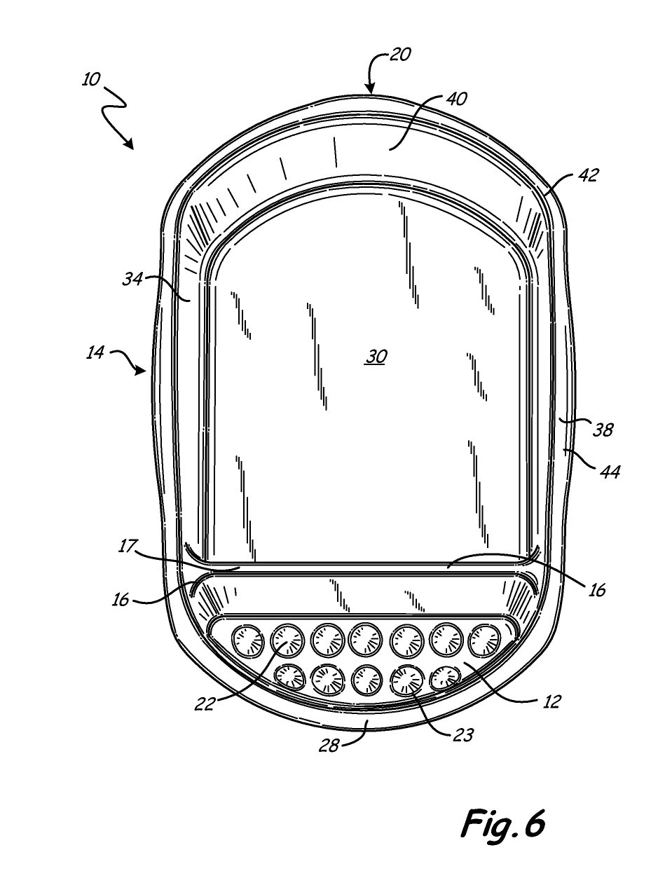

Referring to FIGS. 1-6, the receptacle 10 is typically of a monolith construction being molded of a polymeric material such as polyethylene or polypropylene. However, a modular construction of the receptacle is also contemplated.

The back section 14 of the receptacle 10 includes a substantially flat floor 30 and a continuous sidewall 32 extending upwardly from an outer perimeter 34 of the floor 30. The sidewall 32 includes a left sidewall portion 36 and a right sidewall portion 38 that is substantially parallel to the left sidewall portion 36. Proximate a back end 20 of the receptacle 10 is a back wall portion 40 that connects the right sidewall portion 38 and the left sidewall portion 36. The back wall portion 40 typically has an arcuate configuration, however other configurations are also contemplated including a substantially planar back wall.

Referring to FIGS. 1-3, a rim 42 extends outwardly from a top end of the sidewalls 32. The rim 36 has a substantially “L” shaped configuration with a flat top surface 44 and a downwardly extending lip 46. The rim 42 provides rigidity to the sidewall 32 and allows a purchaser to easily grip and transport the receptacle 10.

Referring to FIGS. 1, 4 and 6, the wall 16 extends between the left sidewall portion 36 to the right sidewall portion 38 and separates the back portion 14 from the front portion 16. A top edge 17 of the wall 16 is lower than the top surface 44 of the sidewalls 32. The wall 16 is typically a height that the animal can easily step over while having a sufficient height to prevent the absorbent material from accidentally being propelled from the back section 14 into the front section 12 or outside of the receptacle 10.

The front section 12 includes a bottom surface 21 that includes a plurality of protuberances 22 having hemispherical surfaces 23 that interrupt the bottom surface 20. The plurality of protuberances 22 are typically positioned in rows and across a width (W) and in columns along a length (L) of the front section 12. The protuberances 22 positioned in the rows and the columns create a grid pattern throughout the front section 12 such that at least one of the pet's paws engage at least one of the protuberances 22. When the pet steps over the wall 16 and into the front section 12, each of the pet's paws engage at least one of the protuberances 22. With the paw positioned on one of the protuberances 22, the pet's weight creates a force on the pet's paw which causes the pet's pads to spread apart and deposit the absorbent material 18 wedged into the pet's paws onto the surface 21 in the front section 12 of the receptacle 10.

The front section 12 includes a front wall 28 extending upwardly from a front edge 30 of the front section 12 where the front wall 28 provides a barrier to retain the deposited absorbent material 18 within the front section 12. The front wall 28 typically has an arcuate configuration and is lower than the wall 16 to provide access into and out of the receptacle 10.

While the plurality of protuberances being in a grid pattern is typical, other configurations of the plurality of protuberances 22 is also typical such as but not limited to a diagonal pattern or a random pattern. While a hemispherical configuration of the protuberances 22 is typical, other configurations of the protuberances 22 are also typical, including but not limited to semi-spheroidal, cubic, frusto-conical and frusto-pyramidal shaped protuberances. Whatever the shape, the protuberances 22 typically provides a convex surface that forces the paw pads to spread apart without causing pain or discomfort to the pet.

A size of the receptacle 10 is varied depending upon the size of the pet. Different configurations besides those illustrated in the figures are also contemplated.

Although the present invention has been described with reference to preferred embodiments, workers skilled in the art will recognize that changes may be made in form and detail without departing from the spirit and scope of the invention.

What is claimed is:

1. A pet litter receptacle comprising:
a back portion for accepting a selected amount of absorbent material;
a front portion comprising a bottom surface having a plurality of protuberances extending upwardly therefrom; and
a wall separating the back portion and the front portion.

2. The pet litter receptacle of claim 1 and wherein the plurality of protuberances comprises a convex outer surface.

3. The pet litter receptacle of claim 1 and wherein the plurality of protuberances comprises a hemisphere outer surface.

4. The pet litter receptacle of claim 1 and wherein the plurality of protuberances comprises at least one row substantially parallel to the wall.

5. The pet litter receptacle of claim 1 and wherein the plurality of protuberances comprises a grid pattern.

6. The pet litter receptacle of claim 1 and wherein the plurality of protuberances comprises two or more rows substantially parallel to each other and the wall.

7. The pet litter receptacle of claim 1 and wherein the front portion comprises an arcuate front edge.

8. The pet litter receptacle of claim 1 and wherein the back portion comprises the wall, having a left end, a right end and a continuous side wall that connects the left and right ends of the wall.

9. The pet litter receptacle of claim 8 and wherein a top edge of the continuous side wall is substantially even.

10. A pet litter receptacle comprising:
a back portion;
a selected amount of absorbent material within the back portion;
a front portion comprising a bottom surface having a plurality of protuberances extending upwardly therefrom; and
a wall separating the back portion and the front portion wherein the pet utilizes the back portion for urinating and defecating and wherein the pet steps over the wall and engages at least one of the plurality of protuberances with at least one paw such that pads of the paw spread apart to release any absorbent material from the paw into the front portion.

11. The pet litter receptacle of claim 10 and wherein the plurality of protuberances comprises a convex outer surface.

12. The pet litter receptacle of claim 10 and wherein the plurality of protuberances comprises a hemisphere outer surface.

13. The pet litter receptacle of claim 10 and wherein the plurality of protuberances comprises at least one row substantially parallel to the wall.

14. The pet litter receptacle of claim 10 and wherein the plurality of protuberances comprises a grid pattern.

15. The pet litter receptacle of claim 10 and wherein the plurality of protuberances comprises two or more rows substantially parallel to each other and the wall.

16. The pet litter receptacle of claim 10 and wherein the front portion comprises an arcuate front edge.

17. The pet litter receptacle of claim 10 and wherein the back portion comprises the wall, having a left end, a right end and a continuous side wall that connects the left and right ends of the wall.

18. The pet litter receptacle of claim 17 and wherein a top edge of the continuous side wall is substantially even.
